(19) United States
(12) Patent Application Publication
(10) Pub. No.: US 2010/0014399 A1
(43) Pub. Date: Jan. 21, 2010

(54) INFORMATION REPRODUCING APPARATUS AND METHOD, AND COMPUTER PROGRAM

(75) Inventors: Hitoshi Kudo, Yokohama (JP); Katsuhiro Shiba, Sayama (JP); Katsuhik Goda, Kawagoe (JP); Shogo Suzuki, Meguro (JP); Katsunobu Kobayashi, Kokubunji (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/530,446

(22) PCT Filed: Mar. 8, 2007
(86) PCT No.: PCT/JP2007/054551

§ 371 Date: Sep. 8, 2009

(51) Int. Cl. G11B 20/10

(52) U.S. Cl. 369/47.36; G9B/20.009

(57) ABSTRACT

An information reproducer (1) includes a element (15) for reproducing content data, a first setting element (20) for setting first loop reproduction unit data, a conversion element (20) for generating conversion data by dividing or elongating/contracting a plurality of unit beat data each corresponding to one beat included in first loop reproduction unit data, a second setting element (20) for setting second loop reproduction unit data where (i) the reproduction period is substantially identical to that of the first loop reproduction unit data, and (ii) a beat appears at a timing synchronous with that of a beat appearing in the first loop reproduction unit data by combining the conversion data, and a element (20) for controlling the reproduction element to perform loop reproduction of the first loop reproduction unit data and the second loop reproduction unit data.

### TECHNICAL FIELD

The present invention relates to an information reproducing apparatus and method which reproduces audio information and video information recorded on a recording medium, as well as a computer program used for the information reproducing apparatus.

### BACKGROUND ART

Recently, a recording medium which allows data recording and reproduction by a digital signal, such as a CD and a DVD, has prevailed. Along with that, an information reproducing apparatus which performs a unique reproduction process derived from the digital signal has been developed. For example, a series of video scenes (or image scenes) and each music piece (i.e. content data) are related to each other and recorded on a CD and a DVD. For example, in the case of a movie, video scenes are recorded as a plurality of data groups so that each of the video scenes having a predetermined reproduction time is reproduced in accordance with a series of reproduction sequences specified by a PGC (Program Group Chain) and a play list. For example, in the case of music, music pieces are recorded as a plurality of data groups in which each of the music pieces having a predetermined reproduction time is distinguished by a truck number. Thus, the information reproducing apparatus can perform cue reproduction in which the head address of each video scene or each music piece is searched for and is reproduced, random reproduction in which the reproduction order of each video scene or each music piece is arbitrarily changed, and the like.

As the information reproducing apparatus described above, for example, in addition to a CD player, a DVD player, and the like which are generally prevailed, exclusive equipment (a DJ player) used by a DJ (Disc Jockey) provided with an operating component, such as a turn table, is listed as one example.

Among such DJ players, there is a player which adopts a technology of repeatedly reproducing data between a loop start position and a loop end position (i.e. loop-reproducing) by a user specifying the loop start position and the loop end position (refer to a patent document 1). On the other hand, in the loop reproduction described above, there is known a technology of gradually reducing a loop reproduction period by setting a new loop end position at a midpoint between the loop start position and the loop end position which are initially specified.

Patent document 1: Japanese Patent Application Laid Open No Hei 7-65506

### DISCLOSURE OF INVENTION

### Subject to be Solved by the Invention

However, the loop reproduction period varies in the technology of gradually reducing the loop reproduction period by setting the new loop end position at the midpoint between the loop start position and the loop end position which are initially specified. Thus, depending on timing of reducing the loop reproduction period, there may be a deviation or difference between a rhythm before reducing the loop reproduction period and a rhythm after reducing the loop reproduction period. Moreover, depending on timing of ending the loop reproduction and starting normal reproduction, there may be a deviation or difference between a rhythm before ending the loop reproduction and a rhythm after ending the loop reproduction and starting the normal reproduction. This is not preferable in the DJ's world in which a better sound is required.

The aforementioned problem is listed as one example of the subject to be solved by the present invention. It is therefore an object of the present invention to provide an information reproducing apparatus and method which allows loop reproduction in a more preferable aspect, as well as a computer program which makes a computer as the information reproducing apparatus.

### Means for Solving the Subject

The above object of the present invention can be achieved by an information reproducing apparatus provided with: a reproducing device for reproducing content data; a first setting device for setting first loop reproduction unit data which is a data portion between a predetermined reproduction start time point and a reproduction end time point after the lapse of time corresponding to a plurality of beats from the reproduction start time point, of the content data; a converting device for generating converted data by dividing or extending at least one of a plurality of unit beat data each of which corresponds to one beat and which are included in the first loop reproduction unit data; a second setting device for setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and a controlling device for controlling the reproducing device to loop-reproduce the first loop reproduction unit data and the second loop reproduction unit data.

The above object of the present invention can be also achieved by an information reproducing method in an information reproducing apparatus provided with: a reproducing device for reproducing content data, the information reproducing method provided with: a first setting process of setting first loop reproduction unit data which is a data portion between a predetermined reproduction start time point and a reproduction end time point after the lapse of time corresponding to a plurality of beats from the reproduction start time point, of the content data; a converting process of generating converted data by dividing or extending at least one of a plurality of unit beat data each of which corresponds to one beat and which are included in the first loop reproduction unit data; a second setting process of setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and a controlling process of controlling the reproducing device to loop-reproduce the first loop reproduction unit data and the second loop reproduction unit data.

The above object of the present invention can be also achieved by a computer program for reproduction control and for controlling a computer provided in an information reproducing apparatus provided with: a reproducing device for reproducing content data; a first setting device for setting first loop reproduction unit data which is a data portion between a predetermined reproduction start time point and a reproduction end time point after the lapse of time corresponding to a plurality of beats from the reproduction start time point, of the content data; a converting device for generating converted data by dividing or extending at least one of a plurality of unit beat data each of which corresponds to one beat and which are included in the first loop reproduction unit data; a second setting device for setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and a controlling device for controlling the reproducing device to loop-reproduce the first loop reproduction unit data and the second loop reproduction unit data, the computer program making the computer function as at least one portion of the first setting device, the converting device, the second setting device, and the controlling device.

The operation and other advantages of the present invention will become more apparent from the embodiments described below.

### BRIEF DESCRIPTION OF DRAWINGS

FIG. 1 is a block diagram conceptually showing the basic structure of an optical disc reproducing apparatus in an example.

FIG. 2 is a plan view conceptually showing the appearance of, particularly, an operation device of the optical disc reproducing apparatus in the example.

FIG. 3 is a flowchart conceptually showing a flow of operations of the optical disc reproducing apparatus in the example.

FIG. 4 is an explanatory diagram conceptually showing an aspect of basic loop reproduction.

FIG. 5 is an explanatory diagram conceptually showing one aspect of a loop reproduction pattern obtained by changing a loop reproduction pattern #1 in the basic loop reproduction.

FIG. 6 is an explanatory diagram conceptually showing another aspect of the loop reproduction pattern obtained by changing the loop reproduction pattern #1 in the basic loop reproduction.

FIG. 7 is an explanatory diagram conceptually showing an operation in changing a reproduction target from the loop reproduction pattern #1 in the basic loop reproduction to a loop reproduction pattern obtained by changing the loop reproduction pattern #1.

FIG. 8 is a plan view conceptually showing another appearance of, particularly, the operation device of the optical disc reproducing apparatus in the example.

FIG. 9 is an explanatory diagram conceptually showing one aspect of the loop reproduction pattern obtained by a modified operation example.

FIG. 10 is an explanatory diagram conceptually showing another aspect of the loop reproduction pattern obtained by a modified operation example.

FIG. 11 is an explanatory diagram conceptually showing another aspect of the loop reproduction pattern obtained by a modified operation example.

FIG. 12 is an explanatory diagram conceptually showing another aspect of the loop reproduction pattern obtained by a modified operation example.

FIG. 13 is an explanatory diagram conceptually showing another aspect of the loop reproduction pattern obtained by a modified operation example.

FIG. 14 is an explanatory diagram conceptually showing another aspect of the loop reproduction pattern obtained by a modified operation example.

### DESCRIPTION OF REFERENCE CODES

1 optical disc reproducing apparatus
10 optical pickup
11 RF amplifier
15 content data decoder
16 decoding device
20 system controller
22 video memory
40 operation device
41 jog dial
42 encoder
43 tempo slider
411 loop-in point specification button
412 loop-out point specification button
414 down button
415 up button

### BEST MODE FOR CARRYING OUT THE INVENTION

Hereinafter, as the best mode for carrying out the invention, respective embodiment of the information reproducing apparatus and method, and the computer program of the present invention will be described in order.

(Embodiment of Information Reproducing Apparatus)

An embodiment of the information reproducing apparatus of the present invention is an information reproducing apparatus provided with: a reproducing device for reproducing content data; a first setting device for setting first loop reproduction unit data which is a data portion between a predetermined reproduction start time point and a reproduction end time point after the lapse of time corresponding to a plurality of beats from the reproduction start time point, of the content data; a converting device for generating converted data by dividing or extending at least one of a plurality of unit beat data each of which corresponds to one beat and which are included in the first loop reproduction unit data; a second setting device for setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and a controlling device for controlling the reproducing device to loop-reproduce the first loop reproduction unit data and the second loop reproduction unit data.

According to the embodiment of the information reproducing apparatus of the present invention, by the operation of the reproducing device, the content data including video, music, and the like is reproduced which is recorded on the recording medium such as a CD and a DVD. Here, by the operation of the first setting device, the first loop reproduction unit data is set which is the data portion between the reproduction start time point and the reproduction end time point. As a result, by the operation of the controlling device, it is possible to perform the loop reproduction in which the first loop reproduction unit data is repeatedly reproduced.

In the embodiment, in particular, by the operation of the converting device, at least one of the plurality of unit beat data included in the first loop reproduction unit data is divided or extended. As a result, the converted data is generated. Then, by the operation of the second setting device, the second loop reproduction unit data which is different from the first loop reproduction unit data is set by combining the converted data, as occasion demands. As a result, by the operation of the controlling device, it is possible to perform the loop reproduction in which the second loop reproduction unit data is repeatedly reproduced.

Here, the second loop reproduction unit data has substantially the same reproduction period as that of the first loop reproduction unit data. Moreover, in the second loop reproduction unit data, the beat appears in the timing synchronized with the timing of the beat that appears in the first loop reproduction unit data (e.g. timing that is n or 1/n times (wherein n is a natural number) the timing of the beat that appears in the first loop reproduction unit data), by combining the converted data. Thus, even if the loop reproduction in a different aspect is performed (i.e. even if the reproduction target is changed from one aspect of the loop reproduction to another aspect of the loop reproduction), the loop reproduction period is not changed, and it is possible to preferably prevent such a disadvantage that a deviation or difference occurs between a rhythm before changing the aspect of the loop reproduction and a rhythm after changing the aspect of the loop reproduction.

In addition, in setting the first loop reproduction unit data, if the reproduction start time point is specified, the reproduction end time point is automatically set to a time point after the lapse of time corresponding to the plurality of beats from the reproduction start time point. Thus, it is possible to preferably prevent such a disadvantage that each of the reproduction start time point and the reproduction end time point is shifted from the position of the beat, resulting in the preferable prevention of such a disadvantage that the rhythm of the content data reproduced by the loop reproduction is disrupted.

As explained above, according to the information reproducing apparatus in the embodiment, it is possible to perform the loop reproduction in a more preferable aspect.

In one aspect of the embodiment of the information reproducing apparatus of the present invention, if a loop reproduction target is changed from the first loop reproduction unit data to the second loop reproduction unit data, the controlling device controls the reproducing device to start the reproduction of the second loop reproduction unit data at the same reproduction time point as that of the first loop reproduction unit data when the reproduction target is changed.

According to this aspect, if the reproduction target is changed from the first loop reproduction unit data to the second loop reproduction unit data, the reproduction position is no longer unconditionally shifted to the head portion of the second loop reproduction unit data, regardless of the reproduction time point of the first loop reproduction unit data when the reproduction target is changed. In other words, if the reproduction target is changed from the first loop reproduction unit data to the second loop reproduction unit data, the reproduction of the second loop reproduction unit data is started in the timing that is continued from the reproduction of the first loop reproduction unit data. Thus, even if the reproduction target is changed from the first loop reproduction unit data to the second loop reproduction unit data (i.e. even if two types of loop reproduction are performed in different aspects), it is possible to preferably prevent such a disadvantage that the deviation or difference occurs between the rhythm before changing the aspect of the loop reproduction and the rhythm after changing the aspect of the loop reproduction.

In another aspect of the embodiment of the information reproducing apparatus of the present invention, if a loop reproduction target is changed from the second loop reproduction unit data to the first loop reproduction unit data, the controlling device controls the reproducing device to start the reproduction of the first loop reproduction unit data at the same reproduction time point as that of the second loop reproduction unit data when the reproduction target is changed.

According to this aspect, if the reproduction target is changed from the second loop reproduction unit data to the first loop reproduction unit data, the reproduction position is no longer unconditionally shifted to the head portion of the first loop reproduction unit data, regardless of the reproduction time point of the second loop reproduction unit data when the reproduction target is changed. In other words, if the reproduction target is changed from the second loop reproduction unit data to the first loop reproduction unit data, the reproduction of the first loop reproduction unit data is started in the timing that is continued from the reproduction of the second loop reproduction unit data. Thus, even if the reproduction target is changed from the second loop reproduction unit data to the first loop reproduction unit data (i.e. even if two types of loop reproduction are performed in different aspects), it is possible to preferably prevent such a disadvantage that the deviation or difference occurs between the rhythm before changing the aspect of the loop reproduction and the rhythm after changing the aspect of the loop reproduction.

In another aspect of the embodiment of the information reproducing apparatus of the present invention, the second setting device further sets third loop reproduction unit data (i) which has substantially the same reproduction period as that of the first loop reproduction unit data, (ii) in which a beat appears in timing synchronized with timing of a beat that appears in the first loop reproduction unit data, and (iii) which is different from the second loop reproduction unit data, by combining the converted data, and if a loop reproduction target is changed from the second loop reproduction unit data to the third loop reproduction unit data, the controlling device controls the reproducing device to start the reproduction of the third loop reproduction unit data at the same reproduction time point as that of the second loop reproduction unit data when the reproduction target is changed.

According to this aspect, it is possible to perform many types of loop reproduction. In addition, if the loop reproduction target is changed from the second loop reproduction unit data to the third loop reproduction unit data, the reproduction position is no longer unconditionally shifted to the head portion of the third loop reproduction unit data, regardless of the reproduction time point of the second loop reproduction unit data when the reproduction target is changed. In other words, if the reproduction target is changed from the second loop reproduction unit data to the third loop reproduction unit data, the reproduction of the third loop reproduction unit data is started in the timing that is continued from the reproduction of the second loop reproduction unit data. Thus, even if the reproduction target is changed from the second loop reproduction unit data to the third loop reproduction unit data (i.e. even if two types of loop reproduction are performed in different aspects), it is possible to preferably prevent such a disadvantage that the deviation or difference occurs between the rhythm before changing the aspect of the loop reproduction and the rhythm after changing the aspect of the loop reproduction.

In another aspect of the embodiment of the information reproducing apparatus of the present invention, it is further provided with a changing device for changing an aspect of division or extension of at least one of the plurality of unit beat data by the converting device.

According to this aspect, it is possible to perform many types of loop reproduction in various aspects. Incidentally, the change in the aspect of division or extension will be detailed later with reference to the drawings.

(Embodiment of Information Reproducing Method)

An embodiment of the information reproducing method of the present invention is an information reproducing method in an information reproducing apparatus provided with: a reproducing device for reproducing content data, the information reproducing method provided with: a first setting process of setting first loop reproduction unit data which is a data portion between a predetermined reproduction start time point and a reproduction end time point after the lapse of time corresponding to a plurality of beats from the reproduction start time point, of the content data; a converting process of generating converted data by dividing or extending at least one of a plurality of unit beat data each of which corresponds to one beat and which are included in the first loop reproduction unit data; a second setting process of setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and a controlling process of controlling the reproducing device to loop-reproduce the first loop reproduction unit data and the second loop reproduction unit data.

According to the embodiment of the information reproducing method of the present invention, it is possible to receive the same various benefits as those of the embodiment of the information reproducing apparatus of the present invention.

Incidentally, in response to the various aspects of the embodiment of the information reproducing apparatus of the present invention described above, the embodiment of the information reproducing method of the present invention can also adopt various aspects.

(Embodiment of Computer Program)

An embodiment of the computer program of the present invention is a computer program for reproduction control and for controlling a computer provided in an information reproducing apparatus provided with: a reproducing device for reproducing content data; a first setting device for setting first loop reproduction unit data which is a data portion between a predetermined reproduction start time point and a reproduction end time point after the lapse of time corresponding to a plurality of beats from the reproduction start time point, of the content data; a converting device for generating converted data by dividing or extending at least one of a plurality of unit beat data each of which corresponds to one beat and which are included in the first loop reproduction unit data; a second setting device for setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and a controlling device for controlling the reproducing device to loop-reproduce the first loop reproduction unit data and the second loop reproduction unit data (i.e. the aforementioned embodiment of the information reproducing apparatus of the present invention (including its various aspects)), the computer program making the computer function as at least one portion of the first setting device, the converting device, the second setting device, and the controlling device.

According to the embodiment of the computer program of the present invention, the aforementioned embodiment of the information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the embodiment of the information reproducing apparatus of the present invention described above, the embodiment of the computer program of the present invention can also adopt various aspects.

An embodiment of the computer program product of the present invention is a computer program product in a computer-readable medium for tangibly embodying a program of instructions executable by a computer provided in an information reproducing apparatus provided with: a reproducing device for reproducing content data; a first setting device for setting first loop reproduction unit data which is a data portion between a predetermined reproduction start time point and a reproduction end time point after the lapse of time corresponding to a plurality of beats from the reproduction start time point, of the content data; a converting device for generating converted data by dividing or extending at least one of a plurality of unit beat data each of which corresponds to one beat and which are included in the first loop reproduction unit data; a second setting device for setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and a controlling device for controlling the reproducing device to loop-reproduce the first loop reproduction unit data and the second loop reproduction unit data (i.e. the aforementioned embodiment of the information reproducing apparatus of the present invention (including its various aspects)), the computer program product making the computer function as at least one portion of the first setting device, the converting device, the second setting device, and the controlling device.

According to the embodiment of the computer program product of the present invention, the aforementioned embodiment of the information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the information reproducing apparatus of the present invention.

Incidentally, in response to the various aspects in the embodiment of the information reproducing apparatus of the present invention described above, the embodiment of the computer program product of the present invention can also employ various aspects.

The operation and other advantages of the present invention will become more apparent from the example explained below.

As explained above, according to the embodiment of the information reproducing apparatus of the present invention, it is provided with the reproducing device, the first setting device, the converting device, the second setting device, and the controlling device. According to the embodiment of the information reproducing method of the present invention, it is provided with the reproducing device, the first setting process, the converting process, the second setting process, and the controlling process. According to the embodiment of the computer program of the present invention, it makes a computer function as the embodiment of the information reproducing apparatus of the present invention. Therefore, it is possible to perform the loop reproduction in a more preferable aspect.

### Example

Hereinafter, the best mode for carrying out the invention will be explained in each example in order on the basis of the drawings. Incidentally, in the example below, the information reproducing apparatus of the present invention is applied to an optical disc reproducing apparatus, such as a CD player and a DVD player, having various reproduction functions represented by reproduction speed control, tempo control, and rewinding reproduction, or the like. Moreover, the optical disc reproducing apparatus in the example explained below is used as DJ equipment used in continuously reproducing music data or video data while adding various special effects to the data, at a dance floor such as a club and a disco. Incidentally, the “DJ” in the example in effect indicates that the content data in a broad sense, including not only music but also video or the like, is reproduced by using a special technique.

(1) Basic Structure

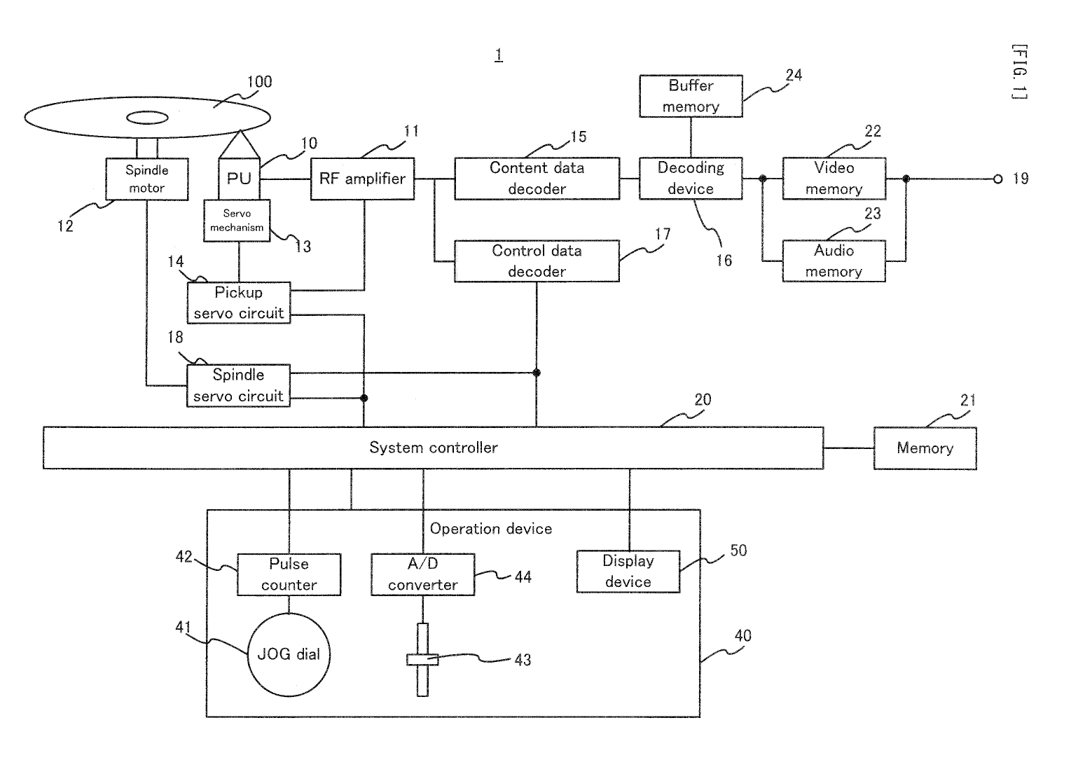

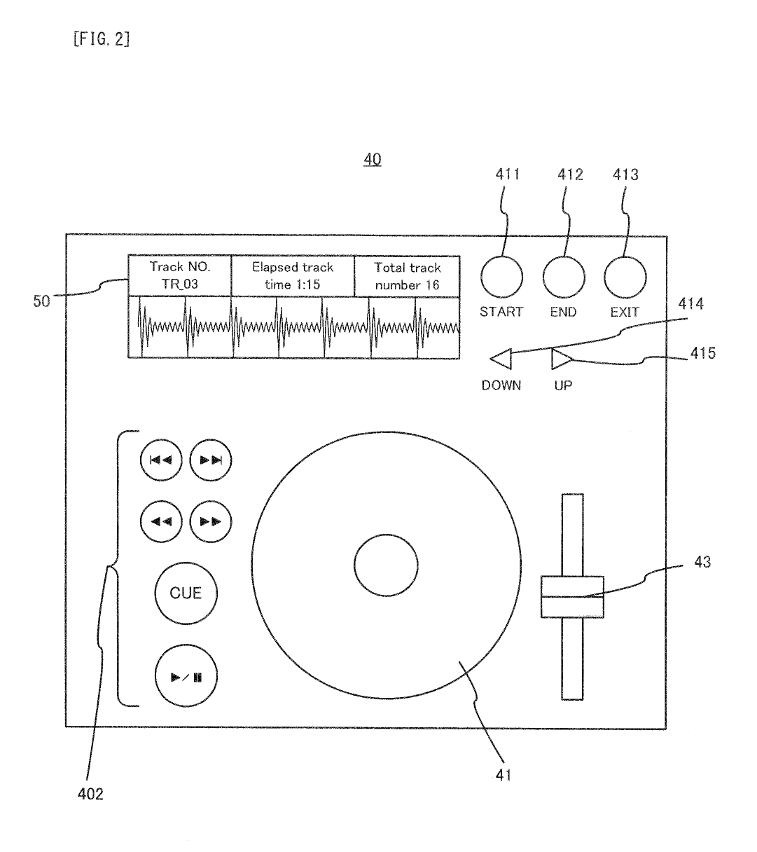

Firstly, with reference to FIG. 1 and FIG. 2, the basic structure of an optical disc reproducing apparatus in the example will be described. FIG. 1 is a block diagram conceptually showing the basic structure of the optical disc reproducing apparatus in the example. FIG. 2 is a plan view conceptually showing the appearance of, particularly, an operation device of the optical disc reproducing apparatus in the example.

As shown in FIG. 1, an optical disc reproducing apparatus 1 is provided with an optical pickup (PU) 10, a RF (Radio Frequency) amplifier 11, a spindle motor 12, a servo mechanism 13, a pickup servo circuit 14, a content data decoder 15, a decoding device 16, a control data decoder 17, a spindle servo circuit 18, an external output terminal 19, a system controller 20, a memory 21, a video memory 22, an audio memory 23, a buffer memory 24, an operation device 40, and a display device 50.

The optical pickup 10 is to read content data and control data from an optical disc 100, and it is formed of a semiconductor laser apparatus, various lenses, an actuator, and the like. More specifically, the optical pickup 10 applies a laser beam LB to the optical disc 100 with a predetermined power. Moreover, the optical pickup 10 is also provided with a PD (Photo Detector) sensor for receiving reflected light of the laser beam LB from the optical disc 100, and it outputs the received reflected light as a read signal to the RF amplifier 11.

The optical pickup 10 is adapted to be displaced in a radial direction of the optical disc 100 or the like in accordance with a tracking error signal, by an actuator, a slider, and the like not illustrated, which are driven by the control of the servo mechanism 13. In addition, the optical pickup 10 is adapted to change a focal point of the laser beam LB in accordance with a focus error signal, thereby performing focus-control, by the control of the servo mechanism 13.

The RF amplifier 11 generates a RF signal on the basis of the read signal outputted from the optical pickup 10 and outputs the generated RF signal to each of the content data decoder 15 and the control data decoder 17. Moreover, the RF amplifier 11 generates an error signal, such as a focus error signal for controlling focus when the optical pickup 10 applies the laser beam LB to the optical disc 100 and a tracking error signal for controlling tracking when the optical pickup 100 applies the laser beam LB to the optical disc 100, on the basis of the read signal outputted from the optical pickup 10. The generated error signal is outputted to the pickup servo circuit 14.

The spindle motor 12 is adapted to rotate the optical disc 100 at a predetermined speed under spindle servo by the spindle servo circuit 18.

The servo mechanism 13 displaces the optical pickup 10 in the radial direction of the optical disc 100, on the basis of a tracking servo control signal outputted from the pickup servo circuit 14. Moreover, the servo mechanism displaces an objective lens included in the optical pickup 10 along the optical axis of the laser beam LB, on the basis of a focus servo control signal outputted from the pickup servo circuit 14.

The pickup servo circuit 14 generates the focus servo control signal and the tracking servo control signal for controlling the servo mechanism 13, on the basis of the error signal outputted from the RF amplifier 11. The generated focus servo control signal and the generated tracking servo control signal are outputted to the servo mechanism 13. In other words, in order to limit or control the occurrence of a focus error and a tracking error, the servo mechanism 13 is feedback-controlled on the basis of the error signal outputted from the RF amplifier 11.

The content data decoder 15 generates a stream signal including a video stream and an audio stream, by decoding the RF signal outputted from the RF amplifier 11. The generated stream signal is outputted to the decoding device 16.

The decoding device 16 constitutes one specific example of the “reproducing device” of the present invention. The decoding device 16 decodes the stream signal and generates a reproduction signal including a video signal and an audio signal. With regard to the generated reproduction signal, the video signal is outputted the video memory 22, and the audio signal is outputted to the audio memory 23.

The video memory 22 temporarily accumulates the video signal inputted from the decoding device 16 and then outputs it to external output equipment, such as, for example, a display, through the external output terminal 19 in desired timing. The external output equipment, such as a display, displays video according to the video signal.

The audio memory 23 temporarily accumulates the audio signal inputted from the decoding device 16 and then outputs it to external output equipment, such as, for example, a speaker, through the external output terminal 19 in desired timing. The external output equipment, such as a speaker, outputs audio (or music) according to the audio signal.

The buffer memory 24 temporarily buffers the reproduction signal generated by decoding the stream signal on the decoding device 16. To the video memory 22 and the audio memory 23, the video signal and the audio signal may be directly outputted from the decoding device 16, or the video signal and the audio signal temporarily accumulated on the buffered memory 24 may be outputted through the decoding device 16.

Incidentally, after a predetermined modulation process is performed on the reproduction signal outputted from the decoding device 16, the modulated reproduction signal may be outputted to the external output equipment. More specifically, for example, modulation by a sawtooth wave may be performed on the reproduction signal. For example, modulation by a square wave may be performed on the reproduction signal. For example, modulation which causes the Doppler effect may be performed on the reproduction signal. For example, modulation by a special waveform imitating a sound of a jet plane may be performed on the reproduction signal. For example, modulation by a special waveform imitating a discharge sound of a gun may be performed on the reproduction signal. Alternatively, modulation by various special waveforms preset by a user or the like may be performed on the reproduction signal. The modulation is preferably performed by a user operating an operation key not illustrated on the operation device 40.

The control data decoder 17 decodes the RF signal outputted from the RF amplifier 11, thereby generating the control data for controlling the reproduction of the content data. The control data include, for example, TOC data or the like recorded in a lead-in area of the optical disc 100, synchronization data recorded with it included in the stream signal, sub-code data including time lapse information in reproducing the content data, and the like, as one specific example. The generated control data is outputted to the system controller 20 and is used to control the reproduction of the content data.

The spindle servo circuit 18 detects an error in the synchronization data with respect to the rotational speed of the spindle motor 12 instructed from the system controller 20, and it feedback-controls the rotation of the spindle motor 12 in order to limit or control the occurrence of the error.

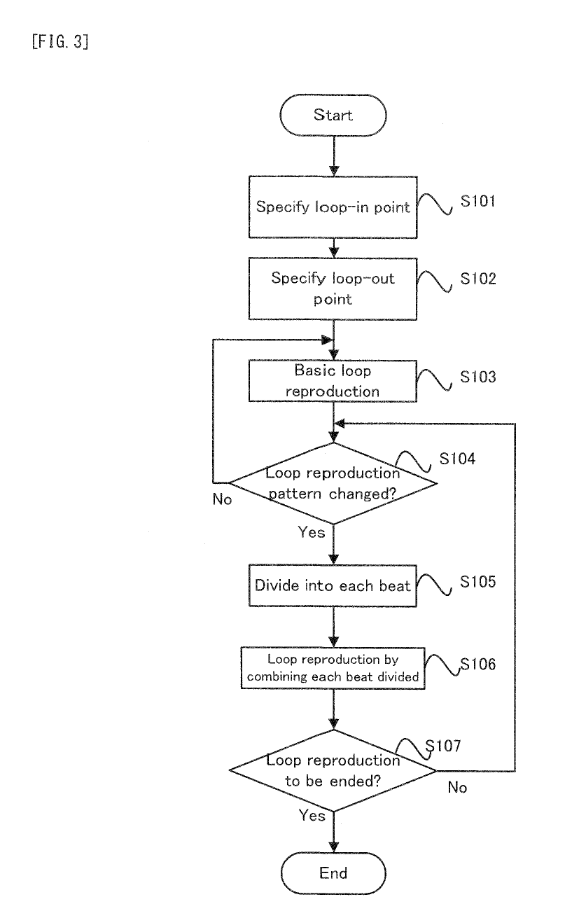

The system controller 20 constitutes one specific example of the “first setting device”, the “converting device”, the “second setting device”, the “controlling device”, and the “converting device” of the present invention. The system controller 20 is provided with a microprocessor and executes a preset system program (or firmware or the like), thereby integrally controlling the operations of the entire optical disc reproducing apparatus 1. Incidentally, the detailed operations of the system controller 20 will be detailed later (refer to FIG. 3 or the like).

The memory 21 is provided with a RAM area for temporarily storing various data or the like necessary for the operations of the optical disc reproducing apparatus 1, or a ROM area for storing a system program or the like which defines the operations of the system controller 20, or the like.

Moreover, the operation device 40 and the display device 50 are connected to the system controller 20. Instruction data from various operation keys provided fro the operation device 40 is outputted to the system controller 20, and the system controller 20 controls the reproduction of the content data in accordance with the instruction data. Moreover, the system controller 20 controls a display operation of the display device 50.

The operation device 40 is provided with a jog dial 41, a pulse counter 42, a tempo slider 43, an A/D converter 44, and the display device 50.

The jog dial 41 is a disc-shaped operation key which is rotatable in both directions. When a user or the like operates it by changing a rotation direction and a rotational speed of the jog dial 41 as occasion demands, it is possible to set forward reproduction and reverse reproduction in accordance with the rotation direction, and it is also possible to change a sound tone or the like of music played on a speaker and a headphone, in accordance with the rotational speed.

Incidentally, the aforementioned forward reproduction means reproducing the content data on the optical disc 100 in recording order, as in a case where an analog record such as a LP is rotated in a forward direction to play music or the like. Therefore, in accordance with the jog dial 41 being rotated in a clockwise direction, music or the like is reproduced as a normal sound. Moreover, in the example, even when the jog dial 41 is stopped, the forward reproduction is performed.

On the other hand, the aforementioned reverse reproduction means reproducing the content data on the optical disc 100 in order opposite to the recording order, as in a case where an analog record such as a LP is rotated in a reverse direction to play music or the like. In other words, since the music or the like is continuously recorded (analog-recorded) on the analog record, when the analog record is rotated in the opposite direction, the music or the like is played in the opposite direction, so that an imitation sound different from the original music or the like is played. When the jog dial 41 is rotated in a counterclockwise direction, the individual content data digital-recorded on the optical disc 100 is reproduced in the opposite order, so that the same imitation sound is generated as in the case where the analog record is rotated and reproduced in the opposite direction.

As described above, by providing the same function as in the reverse reproduction of the analog record, for example, when a user or the like quickly repeats the reciprocating rotation of the jog dial 41 in the clockwise direction and the counterclockwise direction, an imitation sound referred to as a so-called scratch sound (an imitation sound such as “squeak” and “crash”) can be generated. Moreover, when a player referred to as a so-called disc jockey operates the jog dial 41 to generate the aforementioned scratch sound, the player can perform editing for generating rap music or the like, using a CD and a DVD.

The pulse counter 42 counts the pulse width (or the pulse number or the like) of pulses generated by the rotation operation of the jog dial 41, thereby detecting the rotational speed (or angular velocity) of the jog dial 41. In addition, the pulse counter 42 detects the rotation direction of the jog dial 41 on the basis of the pulses generated by the rotation operation of the jog dial 41. The detected rotation direction and rotational speed of the jog dial 41 are outputted to the system controller 20. By this, the system controller 20 recognizes the operation amount of the jog dial 41 operated by a user or the like and allows an effect process or the like according to the operation amount to be performed.

The tempo slider 43 is provided with, for example, a slider button which can slide in a vertical direction. A user or the like displaces the slide button in the vertical direction, thereby changing the reproduction speed of the content data, as occasion demands. For example, by displacing the slider button in an upward direction, it is possible to relatively reduce the reproduction speed of the content data. Alternatively, by displacing the slider button in a downward direction, it is possible to relatively increase the reproduction speed of the content data. The displacement amount of the slider button is detected as an analog value according to the displacement amount and is outputted to the A/D converter 44.

The A/D converter 44 converts the displacement amount of the slider button provided fro the tempo slider 43 detected as the analog value, to a digital value, and then outputs it to the system controller 20. By this, the system controller 20 can relatively increase or relatively reduce the reproduction speed of the content data, in accordance with the displacement amount of the slider button.

The display device 50 displays various information associated with the reproduction of the content data. The display device 50 is provided with a display panel such as a liquid crystal display and a fluorescent tube, and it displays the various information under the control of the system controller 20.

As shown in FIG. 2, in the appearance, the operation device 40 is provided with the jog dial 41, an operation button 402, the tempo slider 43, a loop-in point specification button 411, a loop end point specification button 412, a loop reproduction start/end button 413, a down button 414, an up button 415, and the display device 50.

The operation button 402 is a button which can be pressed by a user and is adapted to change the operations of the optical disc reproducing apparatus 1 by the user pressing the operation button 402. Specifically, by the user pressing the operation button 402, it is possible to give instruction to reproduce, fast-forward, rewind, and pause the content data, start the reproduction from a predetermined cue point, and the like.

The loop-in point specification button 411 is adapted to specify a loop-in point (in other words, a reproduction start time point or a reproduction start position) for performing loop reproduction described later. If a user presses the loop-in point specification button 411 during the reproduction of the content data, a reproduction time point upon the press is specified as the loop-in point.

The loop-out point specification button 412 is adapted to specify a loop-out point (in other words, a reproduction end time point or a reproduction end position) for performing the loop reproduction described later. If a user presses the loop-out point specification button 412 during the reproduction of the content data, a reproduction time point upon the press is specified as the loop-out point.

In the example, however, by the operation of the system controller 20, a time point after the lapse of time corresponding to a predetermined number of beats from the loop-in point specified by the loop-in point specification button 411 may be automatically specified as the loop-out point. In this case, the loop-out point specification button 412 is not necessarily provided.

The loop reproduction start/end button 413 is adapted to give instruction to start and stop the loop reproduction of a content data portion specified by the loop-in point and the loop-out point. If the loop reproduction start/end button 413 is pressed when the loop reproduction is not performed, the loop reproduction is started. On the other hand, if the loop reproduction start/end button 413 is pressed when the loop reproduction is performed, the loop reproduction is stopped, and the normal reproduction of the content data is performed.

Incidentally, the loop reproduction may be also automatically started simultaneously with the specification of the loop-in point and the loop-out point. In this case, there may be no instruction to start the loop reproduction by the loop reproduction start/end button 413, and the loop reproduction start/end button 413 is not necessarily provided.

The down button 414 and the up button 415 constitute one specific example of the “changing device” of the present invention, together with the system controller 20, and they are adapted to give an instruction to change the aspect of the loop reproduction while the loop reproduction is performed. The change in the aspect of the loop reproduction using the down button 414 and the up button 415 will be detailed later.

The display device 50 displays the various information according to the reproduction of the content data including music. For example, in the upper part of the display device 50, there are displayed a truck number of the content data that is currently reproduced, an elapsed time (i.e. a current reproduction time) of the content data that is currently reproduced, and the total track number of the content data recorded on the optical disc 100 currently loaded on the optical disc reproducing apparatus 1, or the like. In an example of the display shown in FIG. 2, it is possible to recognize that the content data with a track number 3 is currently reproduced, that one minute and 15 seconds has elapsed since the reproduction start, and further that the total track number of the content data recorded on the optical disc 100 loaded on the optical disc reproducing apparatus 100 is “16”.

Moreover, in the lower part of the display device 50, there is wave-displayed a beat density or the like of the content data along a reproduction time axis. Alternatively, a signal intensity or the like in each frequency band of the content data that is currently reproduced may be wave-displayed.

Of course, the display content on the display device 50 shown in FIG. 2 is merely one specific example, and obviously, other various information may be displayed.

(2) Operation Example

Next, with reference to FIG. 3, an operation example when the optical disc reproducing apparatus 1 in the example performs the loop reproduction will be described. FIG. 3 is a flowchart conceptually showing a flow of the operation example of the optical disc reproducing apparatus 1 in the example.

As shown in FIG. 3, the loop-in point is specified by using the loop-in point specification button 411 (step S101). In the same manner, the loop-out point is specified by using the loop-out specification button 412 (step S102). However, as described above, the operation in the step S102 may be constructed such that the time point after the lapse of time corresponding to the predetermined number of beats from the loop-in point specified by the loop-in point specification button 411 by the operation of the system controller 20 is automatically specified as the loop-out point. Then, under the control of the system controller 20, the loop reproduction of the content data portion specified by the loop-in point specified in the step S101 and the loop-out point specified by the loop-out point specified in the step S102 (i.e. basic loop reproduction) is performed (step S103). Specifically, the content data portion specified by the loop-in point and the loop-out point specified by the loop-out point is repeatedly reproduced. Incidentally, the loop reproduction may be automatically started by the specification of the loop-in point and the loop-out point, or it may be started after the loop reproduction start/end button 413 is pressed.

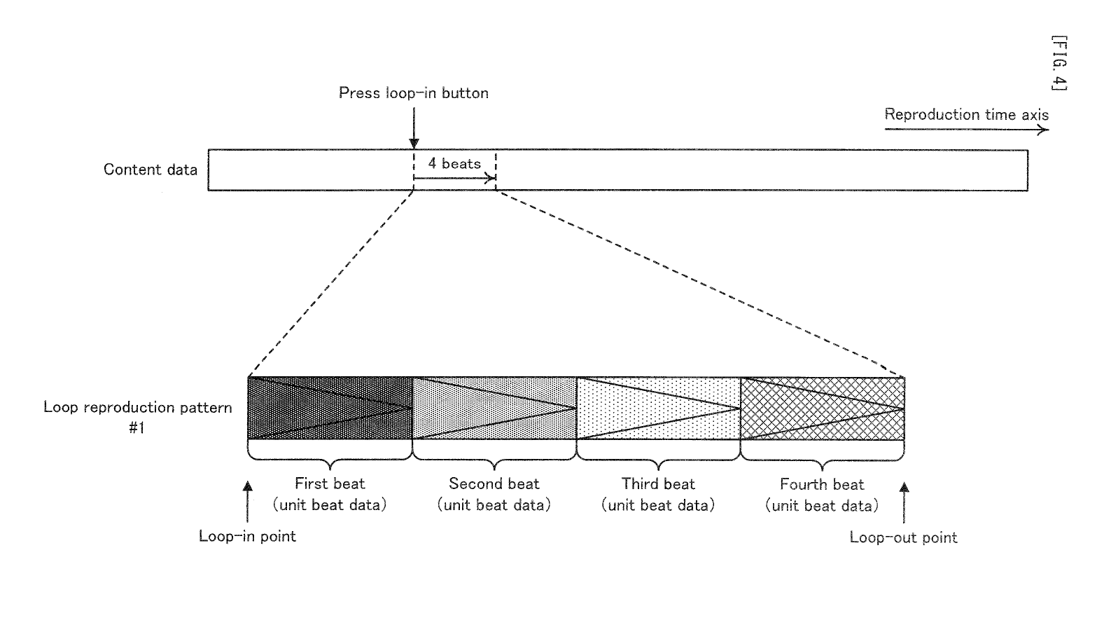

Now, with reference to FIG. 4, an aspect of the basic loop reproduction by the operations in the step S101 to the step S103 in FIG. 3 will be described.

FIG. 4 is an explanatory diagram conceptually showing the aspect of basic loop reproduction. Incidentally, the explanation below will describe an example in a case where such construction is adopted that the time point after the elapse of time corresponding to the predetermined number of beats from the loop-in point specified by the loop-in point specification button 411 is automatically specified as the loop-out point by the operation of the system controller 20.

As shown in FIG. 4, if the loop-in point specification button 411 is pressed, a time point at which the button is pressed is specified as the loop-in point. Then, a time point after the lapse of time corresponding to four beats from the loop-in point is automatically specified as the loop-out point. Therefore, the four-beat data portion is specified as a loop reproduction pattern #1, and the loop reproduction is performed on the loop reproduction pattern #1.

Incidentally, the loop reproduction pattern #1 shown in FIG. 4 constitutes one specific example of the “first loop reproduction unit data” of the present invention, and each one-beat data portion of the four-beat data portion included in the loop reproduction pattern #1 shown in FIG. 4 constitutes one specific example of the “unit beat data” of the present invention. Hereinafter, each one-beat data portion of the four-beat data portion included in the loop reproduction pattern #1 shown in FIG. 4 will be referred to as the “unit beat data” and explained.

In FIG. 3 again, then, under the control of the system controller 20, it is judged whether or not the loop reproduction pattern #1 in the basic loop reproduction is changed (step S104). The judgment may be performed in accordance with the number of times that the down button 414 and the up button 415 are pressed. For example, it is assumed that an initial value of a variable i is “1”, that the variable i is decremented every time the down button 414 is pressed once, and that the variable i is incremented every time the up button 415 is pressed once. In this case, it may be judged that the loop reproduction pattern #1 in the basic loop reproduction is not changed if the variable i is “1”, and it may be judged that the loop reproduction pattern #1 in the basic loop reproduction is changed if the variable i is not “1”.

As a result of the judgment in the step S104, if it is judged that the loop reproduction pattern #1 in the basic loop reproduction is not changed (the step S104: No), the operational flow returns to the step S103 to continue the loop reproduction of the loop reproduction pattern #1.

On the other hand, as a result of the judgment in the step S104, if it is judged that the loop reproduction pattern #1 in the basic loop reproduction is changed (the step S104: Yes), then, under the control of the system controller 20, the division number of the four unit beat data included in the loop reproduction pattern #1 is determined in accordance with the number of times that the down button 414 and the up button 415 are pressed, and each of the four unit beat data is divided (step S105). Here, each of the four unit beat data may be divided by the number of variables i described above. For example, when the up button 415 is pressed once, the variable i is “2”, so that each of the four unit beat data may be divided into two data portions.

Then, under the control of the system controller 20, the loop reproduction pattern is generated by combining one portion of the divided data portions, and the generated loop reproduction pattern is loop-reproduced (step S106).

Then, it is judged whether or not the loop reproduction is to be ended (step S107). If it is judged that the loop reproduction is not to be ended (the step S107: No), the operational flow returns to the step S104 to continue the subsequent operations. On the other hand, if it is judged that the loop reproduction is to be ended (the step S107: Yes), the loop reproduction is ended.

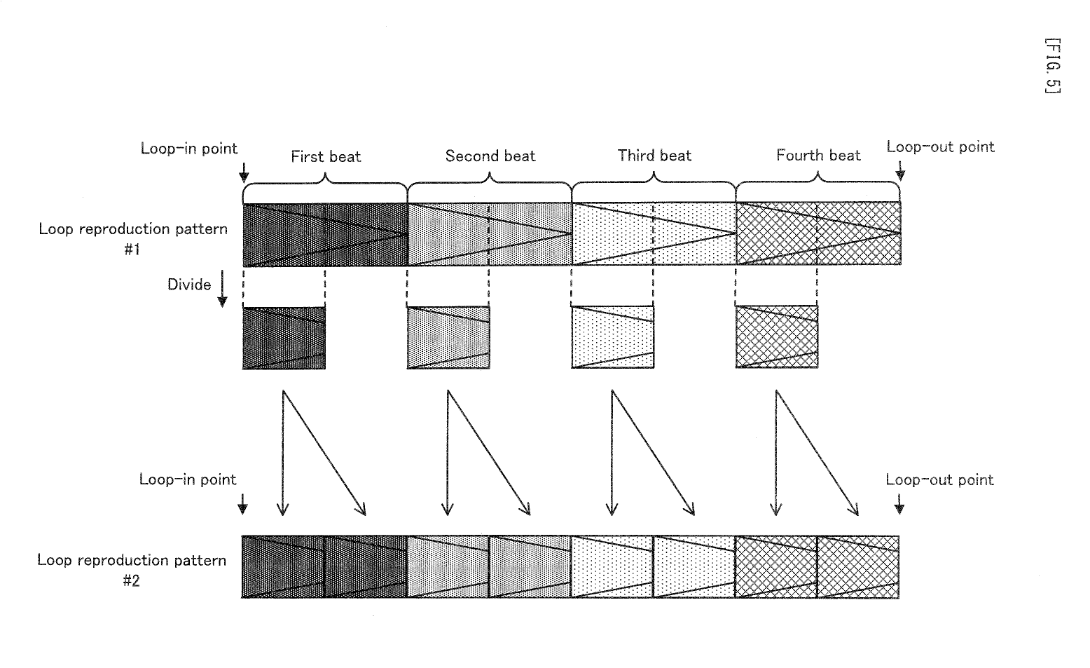

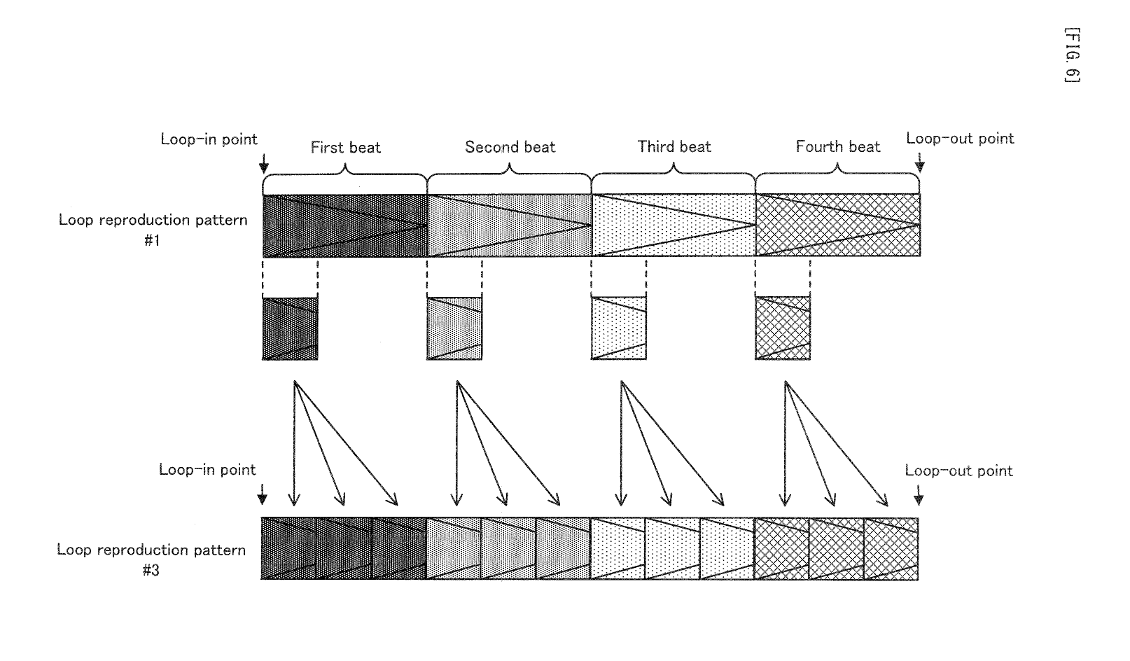

Now, with reference to FIG. 5 and FIG. 6, aspects of the loop reproduction pattern #1 in the basic loop reproduction will be explained. Each of FIG. 5 and FIG. 6 is an explanatory diagram conceptually showing an aspect of the loop reproduction pattern obtained by changing the loop reproduction pattern #1 in the basic loop reproduction.

As shown in FIG. 5, if the variable i is “2”, each of the four unit beat data included in the loop reproduction pattern #1 is divided into two data portions. Then, by using the head data portion of the two data portions of each of the four unit beat data, a loop pattern reproduction #2 shown in the lower part of FIG. 5 is generated. Specifically, by combining two data portions each of which is the head data portion of the divided two data portions of the first-beat unit beat data, the first beat of the loop reproduction pattern #2 is formed. In the same manner, by combining two data portions each of which is the head data portion of the divided two data portions of the second-beat unit beat data, the second beat of the loop reproduction pattern #2 is formed. In the same manner, by combining two data portions each of which is the head data portion of the divided two data portions of the third-beat unit beat data, the third beat of the loop reproduction pattern #2 is formed. In the same manner, by combining two data portions each of which is the head data portion of the divided two data portions of the fourth-beat unit beat data, the fourth beat of the loop reproduction pattern #2 is formed.

In the same manner, as shown in FIG. 6, if the variable i is “3”, each of the four unit beat data included in the loop reproduction pattern #1 is divided into three data portions. Then, by using the head data portion of the three data portions of each of the four unit beat data, a loop pattern reproduction #3 shown in the lower part of FIG. 6 is generated. Specifically, by combining three data portions each of which is the head data portion of the divided three data portions of the first-beat unit beat data, the first beat of the loop reproduction pattern #3 is formed. In the same manner, by combining three data portions each of which is the head data portion of the divided three data portions of the second-beat unit beat data, the second beat of the loop reproduction pattern #3 is formed. In the same manner, by combining three data portions each of which is the head data portion of the divided three data portions of the third-beat unit beat data, the third beat of the loop reproduction pattern #3 is formed. In the same manner, by combining three data portions each of which is the head data portion of the divided three data portions of the fourth-beat unit beat data, the fourth beat of the loop reproduction pattern #3 is formed.

As can be seen from the loop reproduction pattern #2 shown in FIG. 5 and the loop reproduction pattern #3 shown in FIG. 6, the reproduction period of the loop reproduction pattern #1 in the basic loop reproduction is equal to the reproduction period of each of the loop reproduction pattern #2 and the loop reproduction pattern #3. Moreover, beat timing in the loop reproduction pattern #1 in the basic loop reproduction and beat timing in each of the loop reproduction pattern #2 and the loop reproduction pattern #3 have a relation in which they are synchronized.

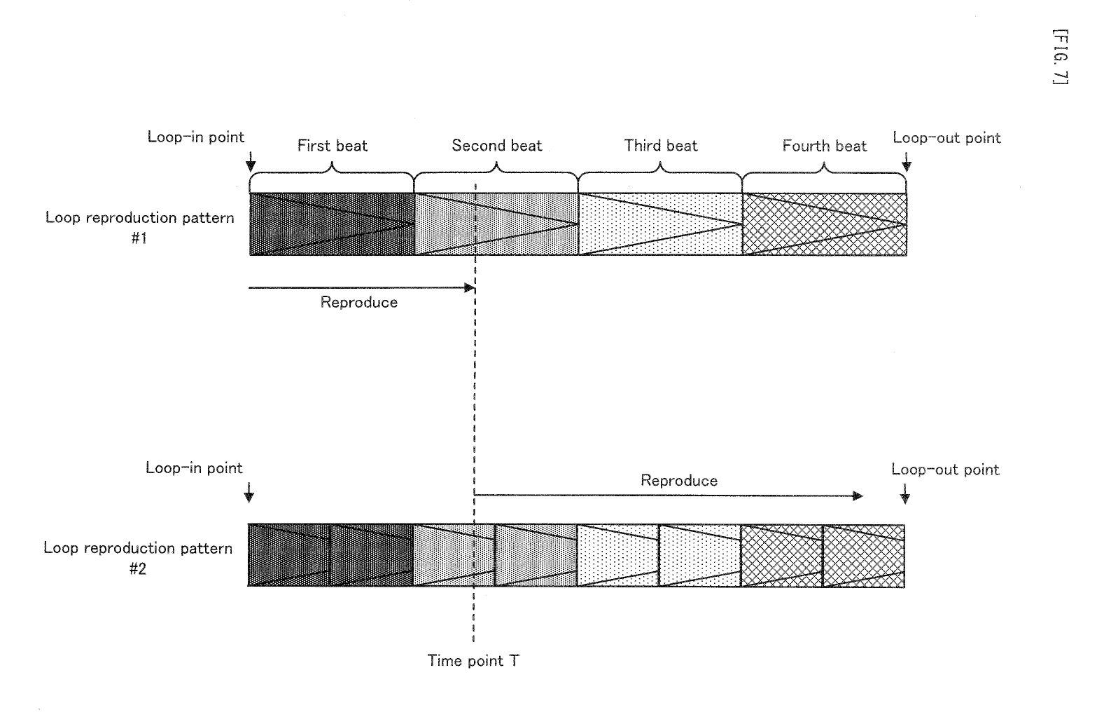

Here, in changing a reproduction target from the loop reproduction pattern #1 to the loop reproduction pattern #2, under the control of the system controller 2, the reproduction of the loop reproduction pattern #2 is started at the same reproduction time point as that of the loop reproduction pattern #1 when the reproduction target is changed. Specifically, as shown in FIG. 7, if the reproduction target is changed from the loop reproduction pattern #1 to the loop reproduction pattern #2 at a time point T of the second-beat unit beat data in the loop reproduction pattern #1, the reproduction of the loop reproduction pattern #2 is started at the time point T.

As described above, since the reproduction period of the loop reproduction pattern #1 in the basic loop reproduction is equal to the reproduction period of each of the loop reproduction pattern #2 and the loop reproduction pattern #3, even if the loop reproduction in a different aspect is performed (i.e. even if the reproduction target is changed from the loop reproduction pattern #1 to the loop reproduction pattern #2), the reproduction period is not changed. Thus, it is possible to preferably prevent such a disadvantage that a deviation or difference occurs between a rhythm before changing the aspect of the loop reproduction and a rhythm after changing the aspect of the loop reproduction.

In addition, by specifying the loop-in point in generating the loop reproduction pattern #1, the loop-out point is automatically set to the time point after the lapse of time corresponding to the four beats from the loop-in point. Thus, it is possible to preferably prevent such a disadvantage that each of the loop-in point and the loop-out point is shifted from the position of the beat, resulting in the preferable prevention of such a disadvantage that the rhythm of the content data reproduced by the loop reproduction is disrupted.

Moreover, even if the reproduction target is changed from the loop reproduction pattern #1 to the loop reproduction pattern #2, the reproduction time point of the loop reproduction pattern #1 before the change is continued on the reproduction time point of the loop reproduction pattern #2 after the change. Thus, it is possible to more preferably prevent such a disadvantage that the deviation or difference occurs between the rhythm before changing the aspect of the loop reproduction and the rhythm after changing the aspect of the loop reproduction.

Incidentally, the operation in the step S105 in FIG. 3 is preferably performed in advance, together with the operations in the step S101 to the step S102. Moreover, the loop reproduction pattern #2 or the like generated by combining the data portions obtained by dividing the unit beat data is preferably stored in the buffer memory 24 or the like in advance. By this, almost simultaneously with the press of the down button 411 and the up button 415, the aspect of the loop reproduction can be changed.

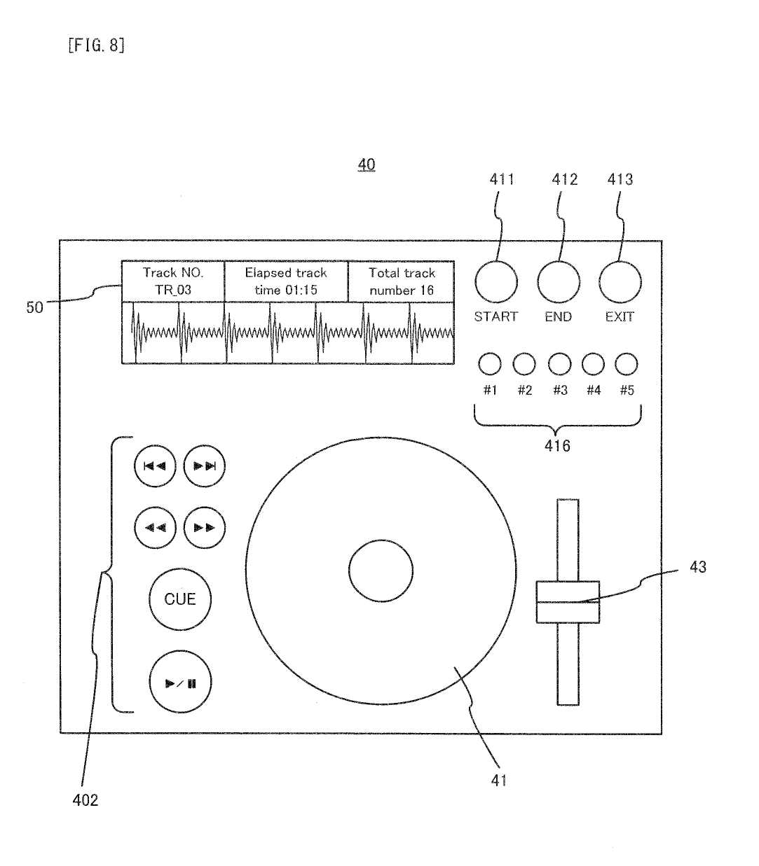

Moreover, the aforementioned operation example explains such construction that the down button 414 and the up button 415 are provided; however, as shown in FIG. 8, there may be provided a plurality of loop reproduction pattern specification buttons 416 each of which can directly specify the loop reproduction pattern #2 or the like. For example, in the example shown in FIG. 8, there are provided five loop reproduction pattern specification buttons 416 which can directly specify the loop reproduction pattern #1, the loop reproduction pattern #2, the loop reproduction pattern #3, a loop reproduction pattern #4, and a loop reproduction pattern #5, respectively. Even in such construction, obviously, it is possible to preferably receive the aforementioned various effects.

Moreover, the aforementioned operation example explains the operation of dividing the unit beat data in the content data to be loop-reproduced if one portion of the content data recorded on the optical disc is loop-reproduced. However, even if the loop reproduction is not performed, each unit beat data included in the entire content data may be divided into n data portions, and n data portions each of which is at least one of the divided n data portions may be combined. In other words, in addition to or instead of targeting the content data to be loop-reproduced, the entire content data may be targeted to perform the aforementioned various operations.

(3) Modified Operation Examples

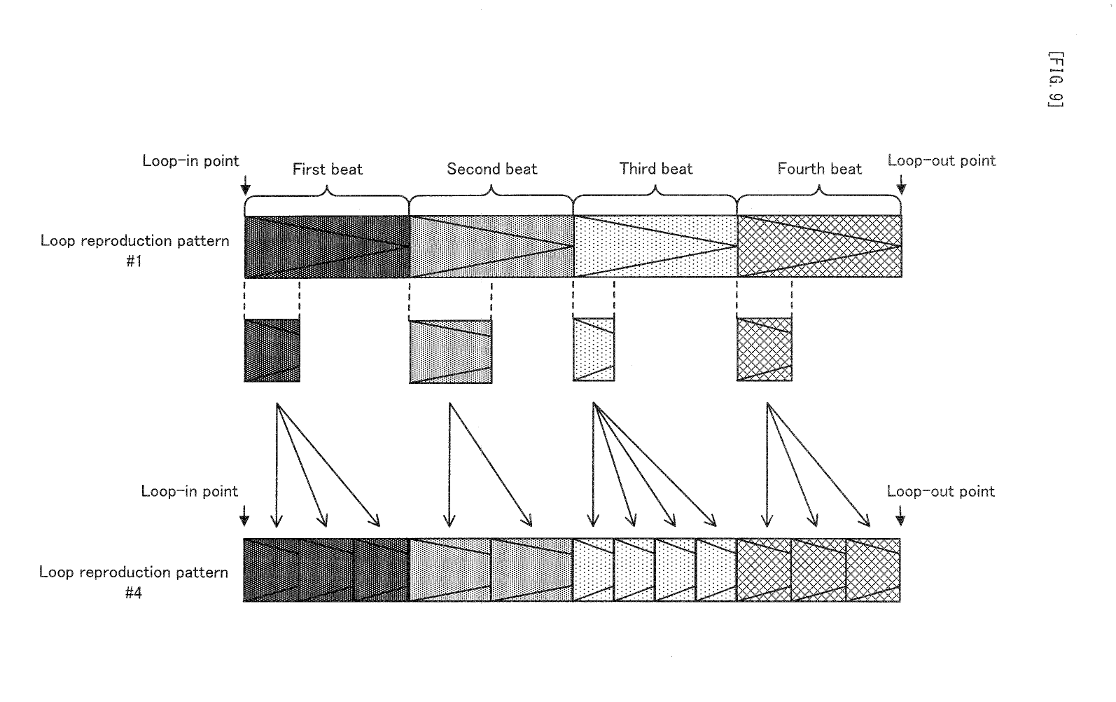

Next, with reference to FIG. 9 to FIG. 14, modified operation examples of the optical disc reproducing apparatus 1 in the example will be described. Here, an explanation will be given on the modified operation examples in generating the loop reproduction pattern obtained b changing the loop reproduction pattern #1 in the basic loop reproduction. Each of FIG. 9 to FIG. 14 is an explanatory diagram conceptually showing an aspect of the loop reproduction pattern obtained by the modified operation example.

As shown in FIG. 9, the division number may be changed in each unit beat data. For example, the first beat of a loop reproduction pattern #4 may be formed by dividing the first-beat unit beat data into three data portions and by combining three data portions each of which is the head data portion of the divided three data portions. In the same manner, the second beat of the loop reproduction pattern #4 may be formed by dividing the second-beat unit beat data into two data portions and by combining two data portions each of which is the head data portion of the divided two data portions. In the same manner, the third beat of the loop reproduction pattern #4 may be formed by dividing the third-beat unit beat data into four data portions and by combining four data portions each of which is the head data portion of the divided four data portions. In the same manner, the fourth beat of the loop reproduction pattern #4 may be formed by dividing the fourth-beat unit beat data into three data portions and by combining three data portions each of which is the head data portion of the divided three data portions.

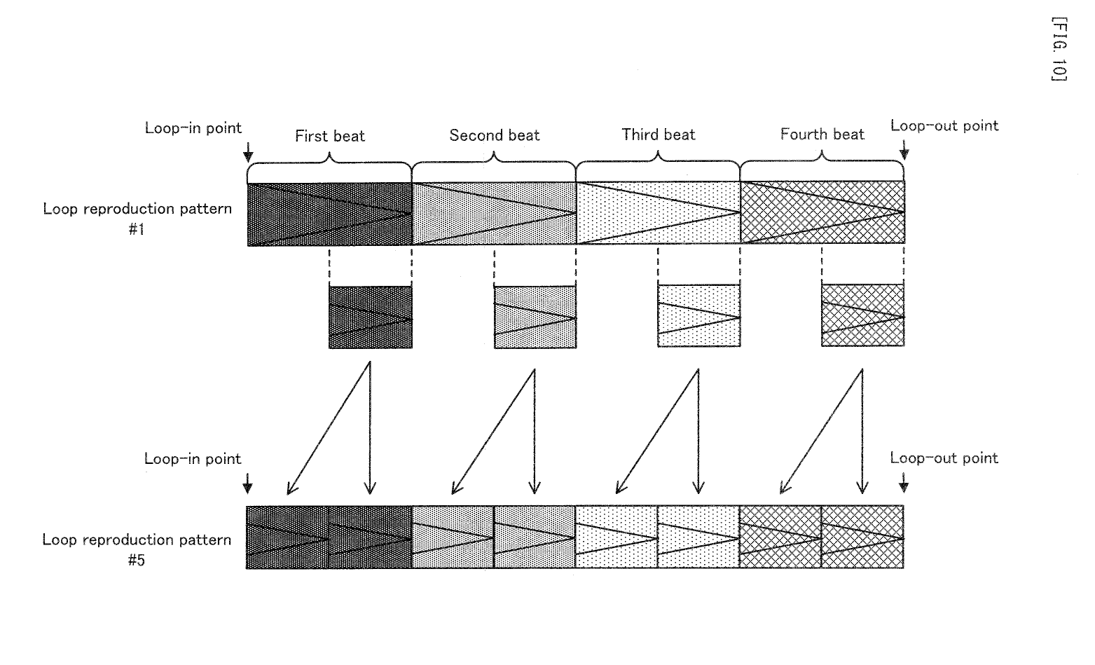

As shown in FIG. 10, a loop reproduction pattern #5 may be generated by dividing each unit beat data into a plurality of data portions and by combining the tail data portion of the divided plurality of data portions. In other words, the loop reproduction pattern #5 may be generated by combining the tail data portion, instead of the head data portion of the divided plurality of data portions.

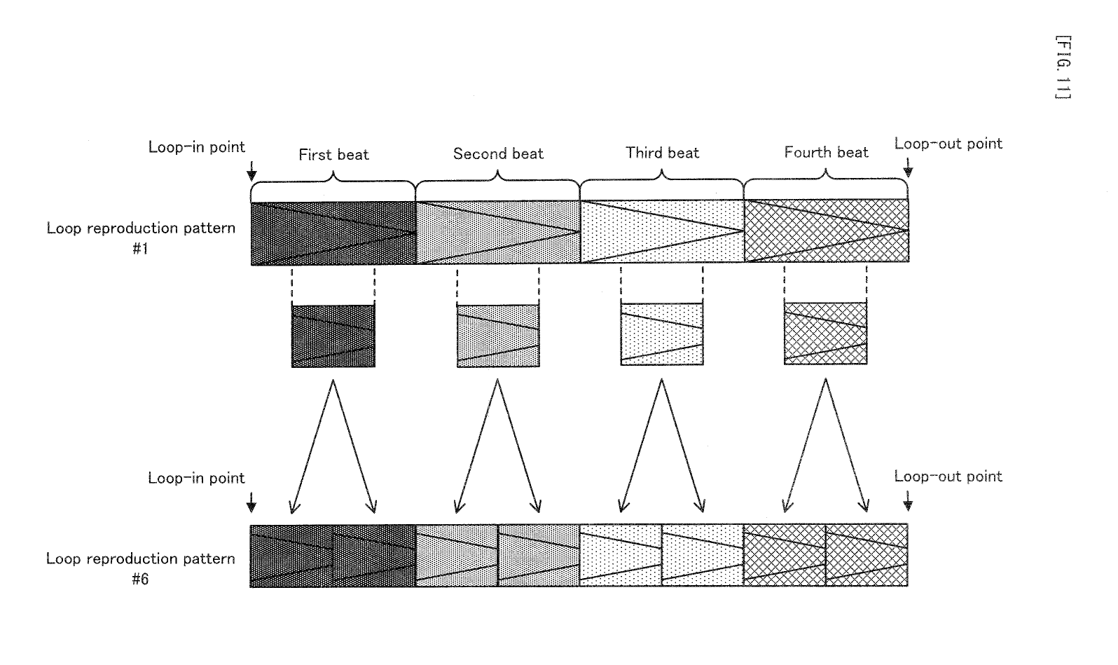

As shown in FIG. 11, a loop reproduction pattern #6 may be generated by extracting a data portion with a length corresponding to 1/n (½ in FIG. 11) of each beat length from each unit beat data and by combining n (2 in FIG. 11) extracted data portions. In other words, in addition to or instead of dividing each unit beat data into n data portions, the data portion with the length corresponding to 1/n (½ in FIG. 11) of each beat length may be extracted from an arbitrary portion of each unit beat data.

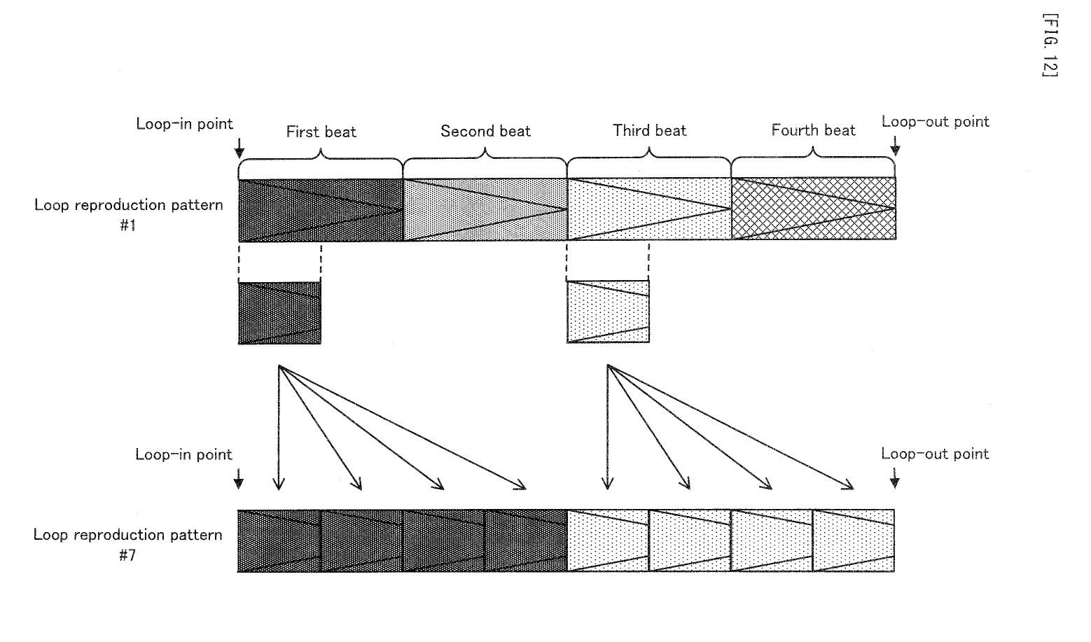

As shown in FIG. 12, by using the nth-beat unit beat data in the loop reproduction pattern #1 in the basic loop reproduction, the data other than the nth beat in the loop reproduction pattern obtained by changing the loop reproduction pattern #1 may be generated. For example, the first beat and the second beat of a loop reproduction pattern #7 may be formed by dividing the first-beat unit beat data into two data portions and by combining four data portions each of which is the head data portion of the divided two data portions. In the same manner, the third beat and the fourth beat of the loop reproduction pattern #7 may be formed by dividing the third-beat unit beat data into two data portions and by combining four data portions each of which is the head data portion of the divided two data portions.

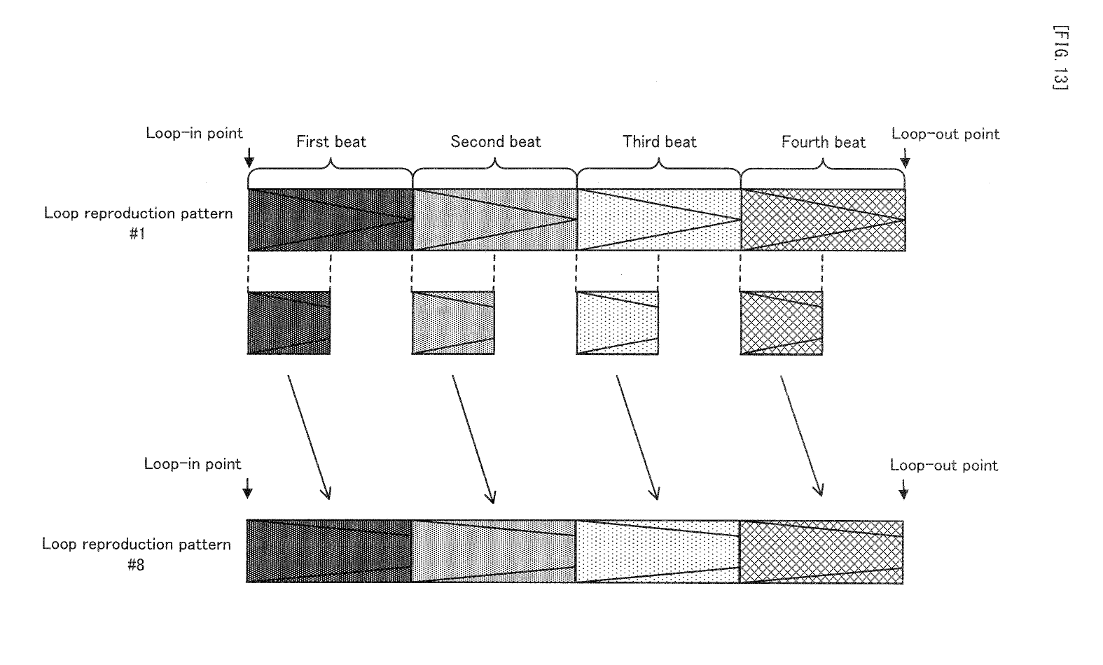

As shown in FIG. 13, a loop reproduction pattern #8 may be generated by dividing each unit beat data into a plurality of data portions and by extending one data portion of the divided plurality of data portions. For example, the first beat of the loop reproduction pattern #8 may be formed by dividing the first-beat unit beat data into two data portions and by extending the head data portion of the divided two data portions to have the beat length. In the same manner, the second beat of the loop reproduction pattern #8 may be formed by dividing the second-beat unit beat data into two data portions and by extending the head data portion of the divided two data portions to have the beat length. In the same manner, the third beat of the loop reproduction pattern #8 may be formed by dividing the third-beat unit beat data into two data portions and by extending the head data portion of the divided two data portions to have the beat length. The fourth beat of the loop reproduction pattern #8 may be formed by dividing the fourth-beat unit beat data into two data portions and by extending the head data portion of the divided two data portions to have the beat length.

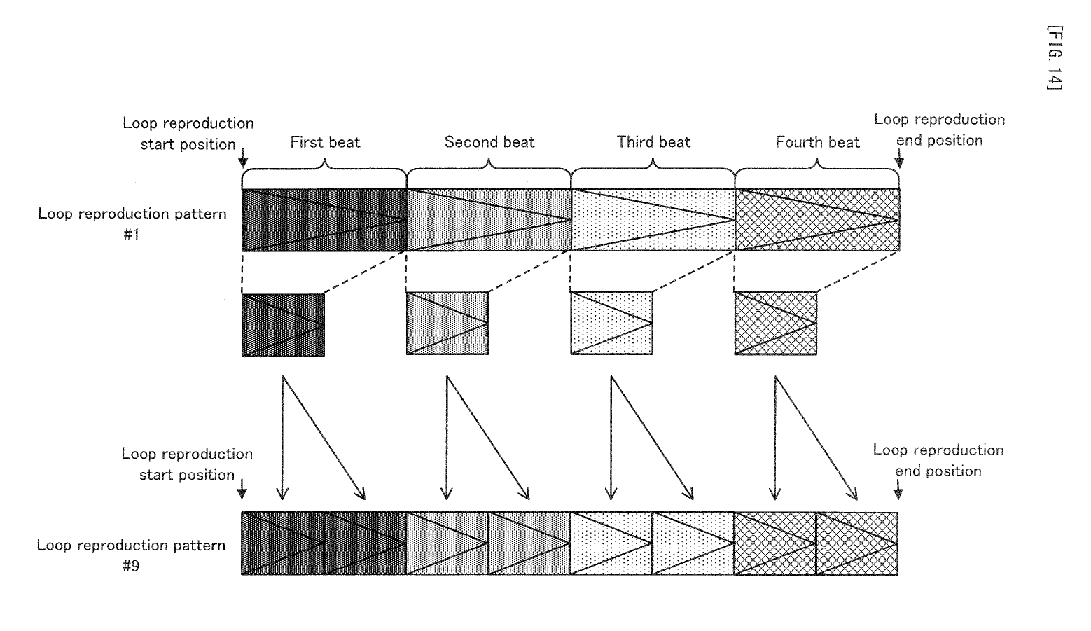

As shown in FIG. 14, a loop reproduction pattern #9 may be generated by reducing each unit beat data and by combining a plurality of the reduced unit beat data portions. For example, the first beat of the loop reproduction pattern #9 may be formed by dividing the first-beat unit beat data into two data portions, by compressing the head data portion of the divided two data portions to ½, and by combining two data compressed data portions. In the same manner, the second beat of the loop reproduction pattern #9 may be formed by dividing the second-beat unit beat data into two data portions, by compressing the head data portion of the divided two data portions to ½, and by combining two data compressed data portions. In the same manner, the third beat of the loop reproduction pattern #9 may be formed by dividing the third-beat unit beat data into two data portions, by compressing the head data portion of the divided two data portions to ½, and by combining two data compressed data portions. In the same manner, the fourth beat of the loop reproduction pattern #9 may be formed by dividing the fourth-beat unit beat data into two data portions, by compressing the head data portion of the divided two data portions to ½, and by combining two data compressed data portions.

In other words, the loop reproduction pattern may be generated by extending or reducing the divided data portions, or by extending or reducing the unit beat data, in addition to or instead of using the divided data portions without change.

Incidentally, the aforementioned example explains the optical disc reproducing apparatus 1 for reproducing the content data recorded on the optical disc 100; however, even in a reproducing apparatus for reproducing the content data recorded on various recording media (e.g. a hard disk, a memory card, and the like) other than the optical disc 100, it is obviously possible to receive the same effects as those received by the optical disc reproducing apparatus 1 by adopting the same construction as that of the optical disc reproducing apparatus 1.

The present invention is not limited to the aforementioned example, but various changes may be made, if desired, without departing from the essence or spirit of the invention which can be read from the claims and the entire specification. An information reproducing apparatus and method, and a computer program, all of which involve such changes, are also intended to be within the technical scope of the present invention.

### INDUSTRIAL APPLICABILITY

The present invention can be applied to an information reproducing apparatus and method which reproduces audio information and video information recorded on a recording medium, and particularly to DJ equipment, VJ equipment, and the like.

1. An information reproducing apparatus comprising:
a reproducing device for reproducing content data;
a first setting device for setting first loop reproduction unit data which is a data portion between a predetermined reproduction start time point and a reproduction end time point after the lapse of time corresponding to a plurality of beats from the reproduction start time point, of the content data;
a converting device for generating converted data by dividing or extending at least one of a plurality of unit beat data each of which corresponds to one beat and which are included in the first loop reproduction unit data;
a second setting device for setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and
a controlling device for controlling said reproducing device to loop-reproduce the first loop reproduction unit data and the second loop reproduction unit data.

2. The information reproducing apparatus according to claim 1, wherein if a loop reproduction target is changed from the first loop reproduction unit data to the second loop reproduction unit data, said controlling device controls said reproducing device to start the reproduction of the second loop reproduction unit data at the same reproduction time point as that of the first loop reproduction unit data when the reproduction target is changed.

3. The information reproducing apparatus according to claim 1, wherein if a loop reproduction target is changed from the second loop reproduction unit data to the first loop reproduction unit data, said controlling device controls said reproducing device to start the reproduction of the first loop reproduction unit data at the same reproduction time point as that of the second loop reproduction unit data when the reproduction target is changed.

4. The information reproducing apparatus according to claim 1, wherein
said second setting device further sets third loop reproduction unit data (i) which has substantially the same reproduction period as that of the first loop reproduction unit data, (ii) in which a beat appears in timing synchronized with timing of a beat that appears in the first loop reproduction unit data, and (iii) which is different from the second loop reproduction unit data, by combining the converted data, and
if a loop reproduction target is changed from the second loop reproduction unit data to the third loop reproduction unit data, said controlling device controls said reproducing device to start the reproduction of the third loop reproduction unit data at the same reproduction time point as that of the second loop reproduction unit data when the reproduction target is changed.

5. The information reproducing apparatus according to claim 1, further comprising a changing device for changing an aspect of division or extension of at least one of the plurality of unit beat data by said converting device.

6. An information reproducing method in an information reproducing apparatus comprising: a reproducing device for reproducing content data, said information reproducing method comprising:
a first setting process of setting first loop reproduction unit data which is a data portion between a predetermined reproduction start time point and a reproduction end time point after the lapse of time corresponding to a plurality of beats from the reproduction start time point, of the content data;
a converting process of generating converted data by dividing or extending at least one of a plurality of unit beat data each of which corresponds to one beat and which are included in the first loop reproduction unit data;
a second setting process of setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and
a controlling process of controlling said reproducing device to loop-reproduce the first loop reproduction unit data and the second loop reproduction unit data.

7. A computer program for reproduction control and for controlling a computer provided in an information reproducing apparatus comprising: a reproducing device for reproducing content data; a first setting device for setting first loop reproduction unit data which is a data portion between a predetermined reproduction start time point and a reproduction end time point after the lapse of time corresponding to a plurality of beats from the reproduction start time point, of the content data; a converting device for generating converted data by dividing or extending at least one of a plurality of unit beat data each of which corresponds to one beat and which are included in the first loop reproduction unit data; a second setting device for setting second loop reproduction unit data (i) which has substantially the same reproduction period as that of the first loop reproduction unit data and (ii) in which a beat appears in timing synchronized with timing of a beat that appears in the first loop reproduction unit data, by combining the converted data; and a controlling device for controlling said reproducing device to loop-reproduce the first loop reproduction unit data and the second loop reproduction unit data,
said computer program making the computer function as at least one portion of said first setting device, said converting device, said second setting device, and said controlling device.
